(19) United States
(12) Patent Application Publication
(10) Pub. No.: US 2011/0217508 A1
(43) Pub. Date: Sep. 8, 2011

(54) ANIMAL SCRATCHER

(75) Inventors: Nicholas A. Forchette, Hugo, MN (US); Cherine Mckenzie, Hugo, MN (US)

(73) Assignee: Itchin' Post, LLC, Hugo, MN (US)

(21) Appl. No.: 12/934,468

(22) PCT Filed: Mar. 24, 2009
(86) PCT No.: PCT/US2009/001844

§ 371 Date: May 27, 2011

Related U.S. Application Data
(60) Provisional application No. 61/039,563, filed on Mar. 26, 2008.

(51) Int. Cl. B32B 7/00; B32B 3/30; B32B 3/10

(52) U.S. Cl. 428/119; 428/172; 428/137

(57) ABSTRACT

This document discloses, among other things, a method and device for protecting property and reducing injury to livestock. A substrate includes a plurality of raised features and is configured for affixation to a fence, barn, or other structure.

### RELATED APPLICATIONS

This application claims priority to U.S. Provisional Application Ser. No. 61/039,563 filed Mar. 26, 2008 and entitled “ANIMAL SCRATCHER,” which is hereby incorporated by reference in its entirety.

### BACKGROUND

All animals, including horses, have a natural inclination to scratch. In the wild, an animal may use a tree, a rock, or the ground to physically stimulate or scratch their body.

In a domesticated environment, an animal will attempt to scratch using a surface found in a pasture, a stall, or in an animal holding area. This can lead to damage to the structure or to injury to the animal.

### SUMMARY

An example of the present subject matter includes an elastomeric pad having a plurality of raised features distributed about a surface. The pad is configured for attachment to a stationary structure. An animal can scratch their body by maneuvering while in physical contact with the raised features.

A variety of examples are contemplated. One example includes a sleeve configured to be affixed to a fence post. One example includes a flexible pad that can be affixed to an outside corner, or an inside corner, of a structure.

One example includes a raised feature having a porous surface. A liquid can be held in the pores of the surface and when the raised feature is deflected, the fluid is brought to the surface of the feature. The feature can be deflected by a rubbing action of an animal, thus causing topical application of the liquid to the animal. The liquid can include an insecticide, a perfume, a cleaner, a drug, a therapeutic agent, or other fluid.

The present subject matter includes a method, an apparatus, and a system.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 includes a perspective view of a pad.

FIG. 2 includes a perspective view of a portion of a pad.

FIG. 3 includes a section view of a portion of a pad.

FIG. 4 includes view of a fence post.

FIG. 5 includes a view of a sleeve with a post.

FIG. 6A and FIG. 6B include views of a portion of a raised feature.

FIG. 7 includes a method of using a pad.

FIG. 8 includes a view of a pad having segments.

### DETAILED DESCRIPTION

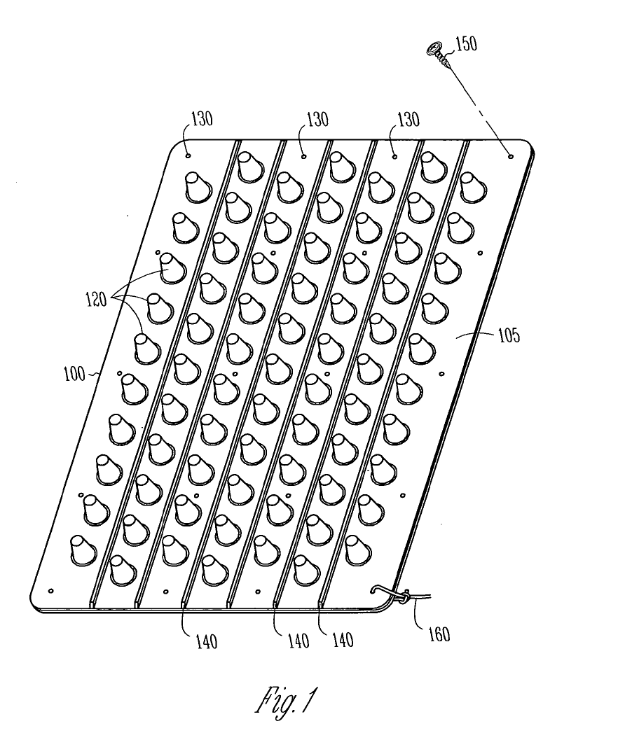

FIG. 1 includes a perspective view of one example of device 100. Device 100 is variously referred to as a pad or as a scratcher. In this example, device 100 includes planar substrate 105. Substrate 105 is generally rectangular in shape and has a first surface and a second surface. Distributed about the first surface is a plurality of raised features. In the figure, each raised feature 120 is conical shaped, however, other shapes are also contemplated, including raised bars, raised lugs, or raised hemispheres. A raised feature is sometimes referred to as a finger. In the example illustrated, the raised features are arranged in a periodic pattern or array. The first surface, in this example, also includes a plurality of reinforcement ribs 140. The reinforcement ribs 140 are in parallel alignment and extend across a length of substrate 105.

Substrate 105 includes a number of holes 130. Each hole 130 passes through substrate 105 and facilitates attachment of device 100 to an underlying structure (not shown in this figure). Device 100 can be attached by means of screw 150 or cordage 160. Cordage 160 can include string, twine, wire, plastic fastener, or other flexible line.

In the example shown, raised features 120 are illustrated in a uniform pattern of staggered rows however; a random or other distribution arrangement is also contemplated. The raised features 120 are substantially normal to the surface of substrate 105.

Device 100 can be fabricated using a mold. In one example, device 100 is molded of a thermoplastic elastomer (TPE) material. Other material can also be used including rubber, plastic or other flexible material. The substrate can be fabricated of the same or different material relative to that of the raised features.

In one example, device 100 has an overall dimension of approximately 14 inches by 24 inches and substrate 105 has a thickness of approximately 0.200 inches. In one example, device 100 has dimensions that resists damage or removal by an animal. For example, a small dimension may afford an animal with an opportunity to work at an edge and remove the device, thus endangering the animal and underlying structure.

As illustrated, each raised feature is configured as a conical finger with an overall length of approximately 2.25 inches and a base diameter of 0.875 inches and an end diameter of approximately 0.5 inches. In one example, the overall length of a conical finger (nub) is one inch relative to the substrate (pad) and the substrate thickness is approximately 0.250″ thick. Other dimensions are also contemplated.

The present subject matter can be fabricated of a TPE material having a durometer of between 25 and 85. The durometer is a measure of hardness or stiffness of a particular material. The durometer, the material, and the dimensions of the device can be selected based on the application.

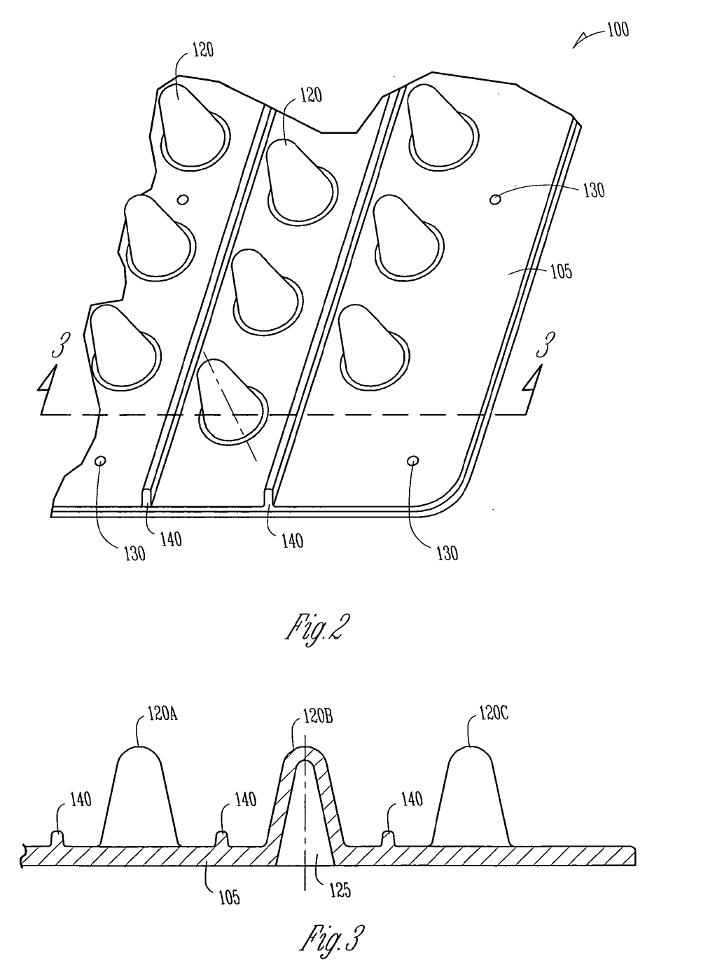

FIG. 2 includes a perspective view of a portion of device 100. The figure illustrates general arrangement of raised features 120, holes 130, and ribs 140.

FIG. 3 includes a section view of a portion of a device corresponding to the cut line shown in FIG. 2. Raised feature 120B is shown in section and raised features 120A and 120C are shown in a profile view. The wall thickness of raised feature 120B is less than that of the thickness of substrate 105. Rib 140 provides longitudinal stiffness to substrate 105. In the figure, the raised feature is hollow, however, in other examples, the raised feature is of solid construction.

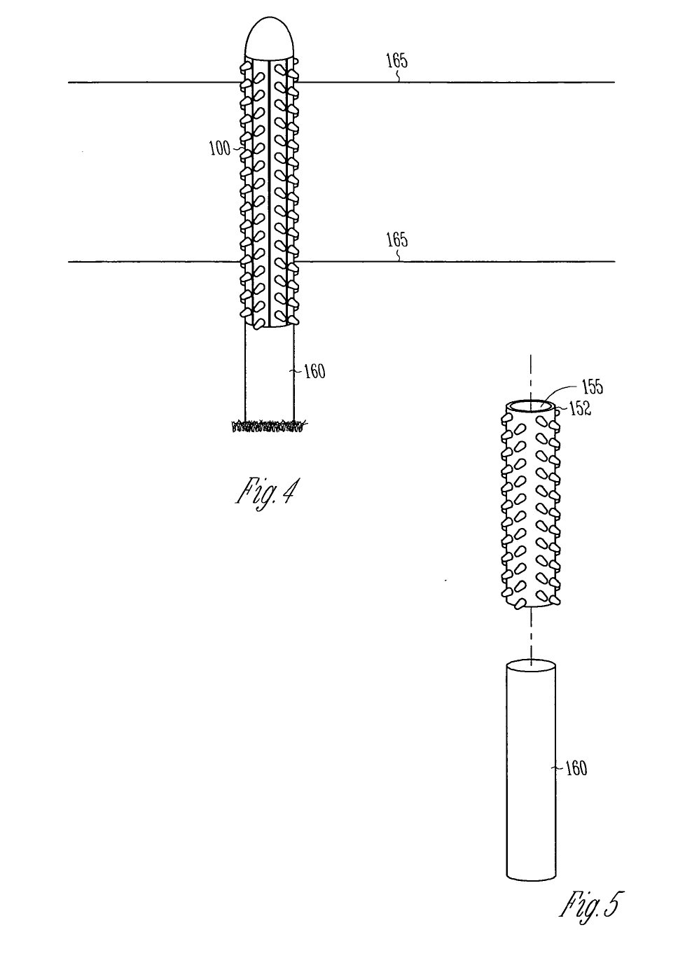

FIG. 4 includes view of device 100 affixed to fence post 160. Fence post 160 is set in the ground and provides support for fence wires 165. A portion of post 160 is wrapped with device 100. Device 100 can partially or wholly encircle a length or a circumference of post 160. Device 100 is held in position on post 160 by a threaded fastener, a nail, a plastic fastener, cordage, or other means not shown in this figure. Vertically aligned reinforcing ribs are visible in the figure.

FIG. 5 includes a view of device 152 with post 160. Device 152 includes a cylindrical substrate having a plurality of raised features distributed about an exterior surface. Aperture 155 has an inside diameter configured to accommodate an outside diameter of post 160. Device 152 can be affixed to post 160 by a friction fit or by means of a fastener as described elsewhere in this document.

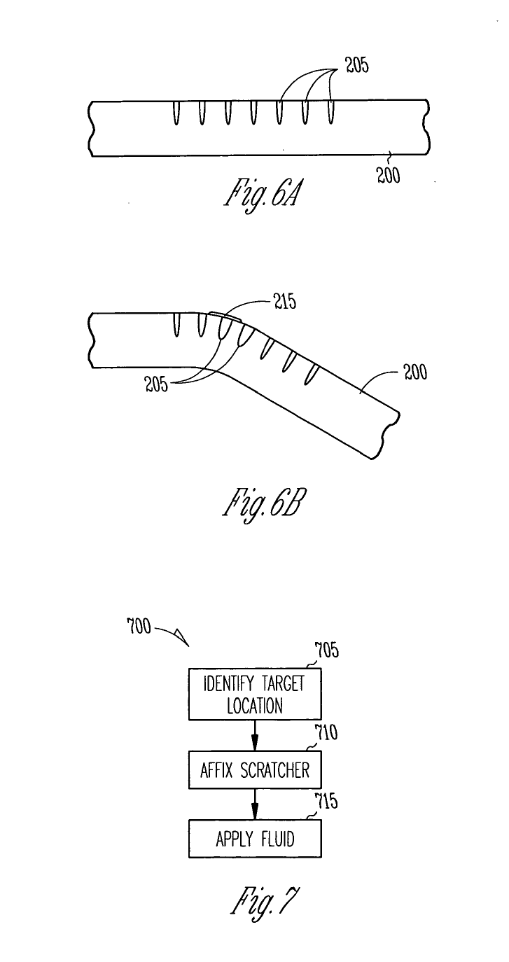

FIG. 6A and FIG. 6B include views of a section of raised feature 200. A surface of raised feature 200 includes a plurality of pores 205. Each pore 205 can be configured to hold an amount of fluid. In FIG. 6A, raised feature 200 is in a natural, or unstressed configuration and fluid is retained within a pore 205. In FIG. 6B, raised feature 200 is deflected and one pore 205 has been distorted and fluid 215 is shown redistributed to a position atop a surface of raised feature 200. Fluid 215 will migrate to a surface of an animal that caused the deflection of raised feature 200.

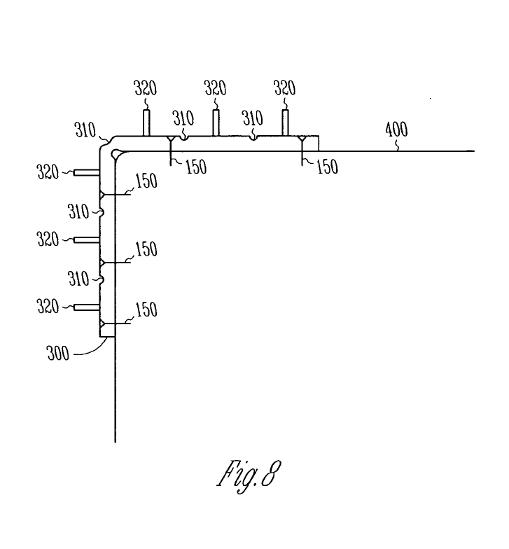

FIG. 7 includes method 700 of using device 100. At 705, a target location for device 100 is identified. This can include a fence post, a corner of a building, a corner of an animal stall, or other structure. At 710, device 100 (sometimes referred to as a scratcher) is affixed to the structure. Affixation can include engaging a threaded fastener (such as a wood screw or machine screw) or unthreaded fastener (such as a nail or rivet), cordage or by other means.

At 715, a fluid is applied to device 100. The fluid can be applied to an exterior surface of device 100 and retained in a porous surface of a raised feature or the substrate. The fluid can be applied by a spray applicator, a brush, or by other means. The fluid can include an insecticide, a perfume, a medicine or drug, or other liquid material.

FIG. 8 includes a view of device 300 having segments. In the figure, device 300 is affixed to an outside corner of structure 400. Structure 400 can include a barn, a fence, a feeder, or other structure. The device can be mounted in an orientation with the raised features projecting horizontally or projecting vertically.

Device 300 includes a plurality of raised features 300. In the example shown, raised features 300 are cylindrical segments having uniform diameter or cross section. Other types of raised features are also contemplated, including shaped sections and combinations of spherical or hemispherical segments. In one example, raised features 300 include a vane-type configuration. In one example, more than one configuration of raised features are present on a particular scratcher.

In the figure, device 300 is shown having six segments, each of which are separated by a hinge portion 310. Hinge portion 310 is illustrated as a live hinge or weakened region relative to other portions of the substrate and extends along a length of device 300. Hinge portion 310, in one example, includes a hinge having a hinge pin. In one example, device 300 is fabricated of sheet material such as plastic or metal, and each raised feature is affixed to the sheet by means of individual attachment, such as a screw or rivet. Device 300 is affixed to structure 400 by screw 150.

An example of the present subject matter provides a rubbing or scratching surface for an animal that reduces risk of injury. In addition, one example serves to protect property (such as a fence or a stall) from damage. The present subject matter can be affixed in a location that affords the animal with access to the device without need of human intervention. An example of the present subject matter also serves to provide a structure that facilitates seasonal shedding of a winter coat of hair.

In one example, a cylindrical substrate (having a plurality of raised features distributed about an external surface) is adapted for installation on a wood fence post. The cylindrical substrate is formed using a molding process and is affixed to the post by a fastener such as a staple, a nail, a threaded fastener, a clip, or by twine or other cordage. One example of the cylindrical substrate is fabricated of flexible material and is configured in the form of a sock or a sleeve. In one example, the raised features affixed to a substrate are all of uniform size and distribution. The size and distribution of the raised features can be varied to produce a structure having a patterned or random configuration suited for use with different animals or for installation on different base structures.

The raised features can be any size and shape. The present subject matter can be fabricated of a porous substance to allow delivery of a liquids or a powder. The present subject matter can be configured for installation on a flat surface or on a curved or round surface.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. An apparatus comprising:
a plurality of elongate elastomeric fingers;
a substrate upon which the fingers are distributed, the fingers aligned substantially normal to a surface of the substrate; and
wherein a finger has a durometer of approximately 65.

2. The apparatus of claim 1 wherein at least one finger is conical shaped.

3. The apparatus of claim 1 wherein at least one finger is hollow.

4. The apparatus of claim 1 wherein at least one finger is fabricated of a thermoplastic elastomer (TPE).

5. A system comprising:
a substrate having a plurality of segments, each segment coupled to an adjacent segment by a hinge;
a plurality of raised features distributed about a surface of the substrate, wherein at least one raised feature has a durometer of approximately 65; and
a structure to which the substrate is affixed.

6. The system of claim 5 wherein the substrate is affixed to the structure by at least one of a staple, a nail, a threaded fastener, and a clip.

7. The system of claim 5 wherein the substrate has a plurality of fastener holes.
